(19) United States
(12) Patent Application Publication
(10) Pub. No.: US 2002/0094079 A1
(43) Pub. Date: Jul. 18, 2002

(54) Cellular phone receptacle

(76) Inventor: Corey Gene Edwards, Placentia, CA (US)

Correspondence Address: Robert T. Spaulding, 550 Elinor Dr., Fullerton, CA, 92835, US

(21) Appl. No.: 09/760,903

(22) Filed: Jan. 17, 2001

(51) Int. Cl. H04M 1/00

(52) U.S. Cl. 379/454

(57) ABSTRACT

A cellular phone receptacle comprising a cylindrically shaped structure having a rounded top and dimensioned to be contained within a standard automobile cup holder. The rounded top includes a groove, dimensioned to accept a cellular telephone. The tactile surface of the mounted receptacle cooperates with the cup holder surfaces to fix the receptacle in place.

### BACKGROUND OF THE INVENTION

1. Field of the Invention

This invention relates generally to cellular phone receptacles and more specifically to cellular phone holders that are contained within cup holders commonly found in automobiles and light trucks.

2. Description of the Prior Art

U.S. Pat. No. 5,745,565 shows a combination cup and cellular phone holder that incorporates a fixed phone holder assembly.

U.S. Pat. No. 6,062,518 shows a cellular phone retainer utilizing a cup holder that incorporates a base including at least one downwardly extending gripping member configured to grip the sidewall of the existing cup holder.

Accordingly, one object and advantage of the present invention is to provide a one-piece cellular phone receptacle that is dimensioned to be placed within a cup holder.

Another object and advantage of the present invention is that the surface of the cellular phone receptacle comprises a tactile surface that enhances the purchase of the installed device.

Another object and advantage of the present invention is that the tactile surface further provides a secure mount for the installed cellular telephone.

Another object and advantage of the present invention is that the closed cell foam rubber construction precludes it from becoming an object of intervention during a collision.

Another object and advantage of the present invention is that the mounted cellular phone may be presented to any passenger by simply rotating the installed device.

Further objects and advantages of this invention will become apparent from consideration of the drawings and ensuing description of it.

### SUMMARY OF THE INVENTION

The present invention, henceforth called a cellular phone receptacle, comprises a cylindrically shaped structure having a rounded top and a flat bottom, a front and a rear, and is generally of larger diameter at the rounded top. The one-piece receptacle is constructed of a closed cell foam rubber material having a tactile surface. The rounded top further includes a groove, symmetrically located at the center of the receptacle, and dimensioned to accept a cellular telephone. The base of the groove is sloped downwardly from the rear to the front of the receptacle so that the driver or any passenger may more easily view the face of the mounted cellular phone.

The cellular phone receptacle is dimensioned to be contained within a standard automobile cup holder. So installed, the cylindrical surface of the receptacle abuts against the bottom and side surfaces of the cup holder. The tactile surface of the receptacle cooperates with surfaces of the cup holder to fix the receptacle in place within the cup holder.

Similarly, the bottom and edge surfaces of the installed cellular phone cooperate with the tactile surface of the receptacle to fix the mounted cellular phone in place.

### BRIEF DESCRIPTION OF THE DRAWINGS

FIG. 1 shows a perspective view of the cellular phone receptacle in which the relationship between the rounded top 1, the tactile surface 3, and the symmetrically located groove 5 may be clearly seen. Also seen in this view is a triangularly shaped slot 7 that provides access to the bottom of the cellular phone 9 for easy removal. A convenient holder for a pen or pencil 11 may also be seen.

FIG. 2 shows a top view of the cellular phone receptacle in which the relationship between the symmetrically located groove 5, the slot 7 and the pen or pencil holder may be seen.

FIG. 3 shows a side view of the cellular phone receptacle showing the downward slope of the groove from the rear 13 of the receptacle to the front 15.

FIG. 4 shows a front view of the cellular phone receptacle showing the groove 5 and the slot 7 as they slope from rear 13 to front 15.

FIG. 5 shows a bottom view of the cellular phone receptacle and depicts how the diameter of the cylindrically shaped structure varies from the bottom 17 to the rounded top 1.

### DESCRIPTION OF THE PREFERRED EMBODIMENT

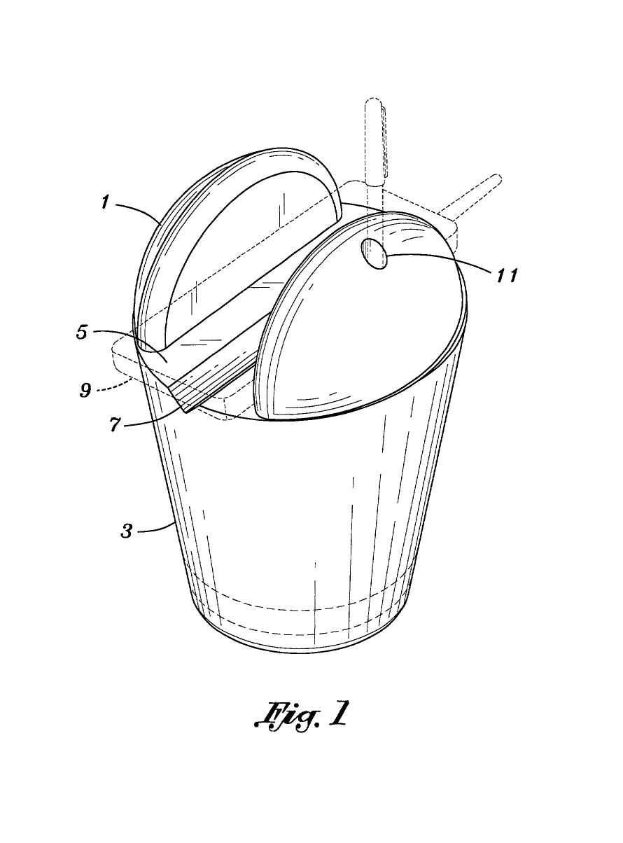

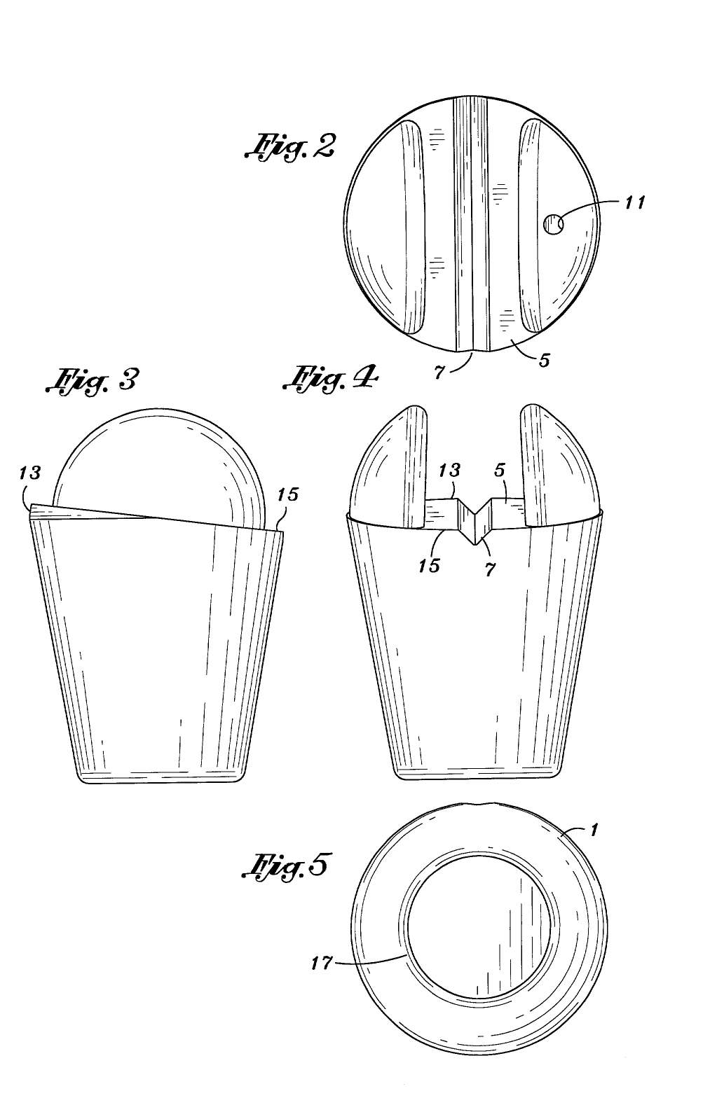

As seen in FIGS. 1 through 5, the cellular phone receptacle is composed of a cylindrically shaped structure having a rounded top 1, a flat bottom 17, a front 15 and a rear 13 and is generally of larger diameter at the rounded top. In the currently preferred embodiment, the one-piece receptacle 3 is constructed of a closed cell foam rubber material having a tactile surface. This choice of material precludes the receptacle from becoming an object of intervention during a collision.

The rounded top includes a groove 5, symmetrically located at the center of the top. The groove is dimensioned to accept a cellular telephone. The base of the groove slops downwardly from the rear to the front of the receptacle. Further included in the rounded top, adjacent to the groove is a pen or pencil holder 11.

The cellular phone receptacle is dimensioned to be contained within a standard automobile cup holder. So installed, the cylindrical surface of the receptacle abuts against the bottom and side surfaces of the cup holder. The tactile surface 3 of the receptacle cooperates with the cup holder surfaces to fix the receptacle in place within the cup holder.

In like manner, the bottom and edge surfaces of the installed cellular telephone 9 cooperate with the tactile surface of the receptacle to fix the mounted cellular phone in place. The base of the groove further includes a triangularly shaped slot 7 that provides access to the bottom of the cellular phone for easy removal.

The cellular telephone may be presented to the driver or any passenger in the automobile by simply grasping the receptacle at the top and rotating it to the desired position.

Based on the descriptions of FIGS. 1 through 7, it can be seen that the present invention provides a one-piece cellular phone receptacle, dimensioned to be contained within an automobile cup holder.

Although the description above contains many specifications, these should not be construed as limiting the scope of the invention, but as merely providing illustrations of some of the presently preferred embodiments of the invention.

What is claimed is:

1) A cellular phone receptacle comprised of cylindrically shaped structure, dimensioned to be contained within a standard automobile cup holder, having a rounded top, a flat bottom, a front, a rear, and a tactile surface so that, when mounted within an automobile cup holder, the tactile surface of the receptacle cooperates with the cup holder surfaces to fix the receptacle in place within the cup holder.

2) The cellular phone receptacle of claim 1, further including a groove, symmetrically located at the center of the rounded top and dimensioned to accept a cellular telephone whereby the mounted cellular telephone is fixed in place by the tactile surface of the receptacle.

3) The groove of claim 2, in which the base of said groove slopes downwardly from the rear of the rounded top of the cellular phone receptacle to the front.

4) The groove of claim 3, in which the base of said groove further includes a triangularly shaped slot that provides access to the bottom of the mounted cellular phone to facilitate removal.

5) The cellular phone receptacle of claim 3, further including a pen or pencil holder located adjacent to the groove.

6) The cellular phone receptacle of claim 1, in which the cylindrically shaped structure is generally of larger diameter at the rounded top.

7) The cellular phone receptacle of claim 1, in which said receptacle is composed of a closed cell foam rubber material to preclude the receptacle from becoming an object of intervention during a collision.

8) A cellular phone receptacle comprising:
A cylindrically shaped structure having a rounded top, a flat bottom, a front, a rear, a tactile surface and dimensioned to be contained within an automobile cup holder wherein the tactile surface of the receptacle cooperates with the cup holder surfaces to fix the receptacle in place within the cup holder.

9) The cellular phone receptacle of claim 8, further including a symmetrically located groove in the rounded top that is dimensioned to accept a cellular telephone whereby the mounted cellular telephone is fixed in place by the tactile surface of the receptacle.

10) The groove of claim 9, wherein the base of the groove slopes downwardly from the rear of the receptacle to the front.

11) The groove of claim 10, further comprising a triangularly shaped slot at the base of the groove that facilitates removal of the mounted cellular telephone.

12) The cellular phone receptacle of claim 10, further including a pen or pencil holder located adjacent to said groove.

13) The cellular phone receptacle of claim 8, in which the cylindrically shaped structure is generally larger in diameter at the top.

14) The cellular phone receptacle of claim 1, in which said receptacle is composed of a closed cell foam rubber material to preclude the receptacle from becoming an object of intervention during a collision.
